(19) United States
(12) Patent Application Publication
(10) Pub. No.: US 2026/0365026 A1
(43) Pub. Date: Nov. 19, 2026

(54) Battery Module

(71) Applicant: HOPPECKE Systemtechnik GmbH, Zwickau (DE)

(72) Inventors: Andreas Ehlert, Zwickau (DE); Finn Rahmann, Paderborn (DE); Stefan Reinhold, Zwickau (DE)

(21) Appl. No.: 19/206,592

(22) Filed: May 13, 2025

(51) Int. Cl. B60L 1/00; B61C 3/00; H01M 10/0525; H01M 10/42; H01M 50/249; H02J 1/00

(52) U.S. Cl. CPC B60L 1/00; H01M 10/0525; H01M 10/425; H01M 50/249; B60L 2200/26; B61C 3/00; H01M 2220/20; H02J 1/00

(57) ABSTRACT

A battery module for supplying power to an on-board network of a train, with a battery, in particular a lithium-ion battery, and switching electronics, wherein the switching electronics have a high-power path for supplying the on-board network on the basis of a first on-board voltage and an auxiliary path for supplying the on-board network on the basis of a second on-board voltage, wherein the high-power path has a first phase with a first switching element and a second phase with a second switching element, wherein the auxiliary path has a first phase with a third switching element and a second phase, wherein the first phase of the auxiliary path is connected upstream of the first switching element to the first phase of the high-power path and wherein the second phase of the auxiliary path is connected downstream of the second switching element to the second phase of the high-power path.

### FIELD

The invention relates to a battery module for supplying power to a train's on-board power supply system, comprising a battery, in particular a lithium-ion battery, and switching electronics.

### BACKGROUND

Battery modules of the type mentioned above are well known in prior art, for which reason separate written reference is not required at this point.

According to prior art, a train has two on-board voltage systems. A second voltage system is used in particular to supply train-side computer systems and/or a train control system. A first voltage system supplies all other systems of the train and enables the train to move even without an external power supply, for example on non-electrified train routes or in an emergency.

According to prior art, two separate battery modules are provided to supply power to the two on-board voltage systems, i.e., a first battery module for the first on-board voltage system and a second battery module for the second on-board voltage system.

Although the above-described design has proven itself in everyday use, there is room for improvement, particularly with regard to optimizing costs and space requirements. The object of the invention is therefore to further develop a battery module of the type mentioned above in such a way that a reliable supply of the two on-board voltage systems of a train is ensured while optimizing costs and space requirements.

### SUMMARY

To achieve this object, the invention proposes a battery module for supplying an on-board network of a train, comprising a battery, in particular a lithium-ion battery, and switching electronics, wherein the switching electronics has a high-power path for supplying the on-board network on the basis of a first on-board voltage and an auxiliary path for supplying the on-board network on the basis of a second on-board voltage, wherein the high-power path has a first phase with a first switching element and a second phase with a second switching element, wherein the auxiliary path has a first phase with a third switching element and a second phase, wherein the first phase of the auxiliary path is connected upstream of the first switching element to the first phase of the high-power path and wherein the second phase of the auxiliary path is connected downstream of the second switching element to the second phase of the high-power path.

The switching electronics of the battery module according to the invention has a high-power path on the one hand and an auxiliary path on the other. The high-power path serves to supply the train's on-board network on the basis of a first on-board voltage of, for example, up to 1000V. The auxiliary path serves to supply the train's on-board network on the basis of a second on-board voltage of, for example, 24 V.

The second on-board voltage can, for example, be used to supply computer systems and/or a control system for the train. The first on-board voltage supplies all other systems of the train, in particular also a drive system for the train for the purpose of movement without an external power supply.

The high-power path has two switchable phases, wherein a first phase is provided with a first switching element and a second phase with a second switching element. The auxiliary path also has two phases, wherein only one of the two phases is switchable. Accordingly, an auxiliary path is provided which has a first phase with a third switching element and a second phase without a switching element.

According to the invention, it is further provided that the first phase of the auxiliary path is connected upstream of the first switching element to the first phase of the high-power path. The second phase of the auxiliary path is connected downstream of the second switching element and to the second phase of the high-power path.

The above-described interconnection makes it possible to supply the two on-board voltage systems of the train as intended with only a single battery and thus also with only a single battery module, namely on the basis of a first on-board voltage and on the basis of a second on-board voltage. In contrast to prior art, the second battery module, which would otherwise be required, can be completely omitted, which is advantageous both for cost reasons and for reasons of space. In particular, the design according to the invention proves to be less cost intensive. In addition, it requires less installation space for its intended use, which also simplifies assembly and disassembly.

Another advantage is that an on-board power supply can take place on the basis of a second on-board voltage of, for example, 24 V, independently of a power supply via the high-power path. In particular, in the event of an emergency, one and the same battery module can be used to provide a power supply as an auxiliary supply via the auxiliary path while a power supply via the high-power path is switched off. This means that even in emergency operation of the train, when the train systems are otherwise switched off, a voltage supply for the train-side computer system or the train control system can be reliably maintained. Nevertheless, unlike prior art, two batteries or two battery modules are not required. It is only necessary that the battery used according to the invention has sufficient capacity, for example a capacity that ensures 90 minutes of emergency power operation.

According to a further feature of the invention, the switching electronics is provided with a DC voltage converter. This DC voltage converter serves to selectively supply the two on-board voltages. In this case, the on-board voltage fed in via the auxiliary path is used in particular to supply power to the train control system, for which purpose it is provided for the DC voltage converter to supply a second on-board voltage of, for example, 24 V. The high-power path serves to supply the on-board network on the basis of a first on-board voltage, which is designed in particular for the intended power supply of the train's drive systems.

According to a further feature of the invention, the DC converter is designed to start up the battery, in particular the lithium-ion battery, without an external power supply. For this purpose, a fourth switching element may be provided, for example. When this is actuated, a power supply, in particular for a train control system, is requested via the DC voltage converter. As soon as the train control system or the train-side computer systems have booted up or are operating as intended, the train's drive systems can be started, resulting in the supply of power to the on-board network based on the first on-board voltage.

The invention further proposes a method for operating a battery module, in particular a battery module of the type described above, in which a power supply for a train-side on-board network is requested by actuating a fourth switching element cooperating with the DC voltage converter, in which, in the event of a fault-free battery, in particular a lithium-ion battery, the second switching element of the second phase of the high-power path is closed and, in order to supply the on-board network on the basis of the second on-board voltage, the third switching element in the first phase of the auxiliary path is closed.

In accordance with this implementation of the method, it is possible to start up the train without an external voltage supply. According to a first step, a voltage supply for the train control system is requested. This is done by activating the fourth switching element. The battery is then checked or determined to be fault-free. As soon as the battery is determined to be fault-free, i.e., the battery is determined to be ready for use as intended, the second switching element of the second phase of the high-power path is closed. If the battery is faulty, it is preferably not possible to activate the second switching element. In a third step, the third switching element in the first phase of the auxiliary path closes, which results in the supply of the on-board power supply system based on the second on-board voltage. The auxiliary path and thus also the second on-board voltage are therefore active, ensuring in particular that the train's own computer systems can operate. However, voltage supply of the on-board network for all other train systems, in particular the drive system, does not take place.

When the second on-board voltage is active, the train can be started for the purpose of movement. For this purpose, according to a further feature of the invention, the first switching element of the first phase of the high-power path is to be closed in order to supply the on-board power supply system on the basis of the first on-board voltage. The train is now ready to go, as the power for the drive motors of the drive system has been enabled.

According to a further feature of the invention, it is provided that, in the event of an emergency signal from the train, the first switching element of the first phase of the high-power path is opened. No power is then available for the drive motors of the train's drive system, which prevents the train from moving. However, the second switching element and the third switching element are still closed, so that the supply of the on-board network continues as intended on the basis of the second on-board voltage. Emergency operation therefore remains active and, in particular, the train's own computer systems and the train control system are supplied with power.

Alternatively, or in the event of a desired unregulated shutdown in an emergency, in particular by rescue services such as the fire department, the third switching element of the first phase of the auxiliary path and/or the second switching element of the second phase of the high-power path are designed to be opened in order to disconnect the train from power. In this case, emergency operation is also no longer active, i.e., not only is the high-power path switched off, but also the auxiliary path. As a result, there is no longer any power supply to the train.

The battery module described above or the method described above offer a number of advantages. If an “emergency stop” is activated on the train, the high-power path is switched off. However, the auxiliary path is not disconnected, so that the on-board power supply is continued, but only on the basis of the second on-board voltage, which means that although the train's drive system is switched off, the train control system and the train's own computer systems can still be operated as intended.

The high-power path can also be started up without external power supply, namely via the voltage converter. The computer systems or the train control system are therefore first started up using the second on-board voltage so that the train is in a ready-to-start state before the actual drive system of the train is supplied with the appropriate on-board voltage.

It is also possible to provide an on-board power supply based on 24 V DC voltage, namely independently of the power supply via the high-power path. This is possible in accordance with the invention despite the absence of a second battery.

Battery states, such as the state of charge and temperature, can be permanently monitored, which allows the battery to be switched off in the event of a critical battery state. In this context, it is also possible to close the second switching element for supplying voltage to the high-power path only after fault-free operation of the lithium-ion battery has been determined in advance.

Another advantage is that the power consumption of the entire system in the standby operation of the control system is low.

### BRIEF DESCRIPTION OF THE DRAWING

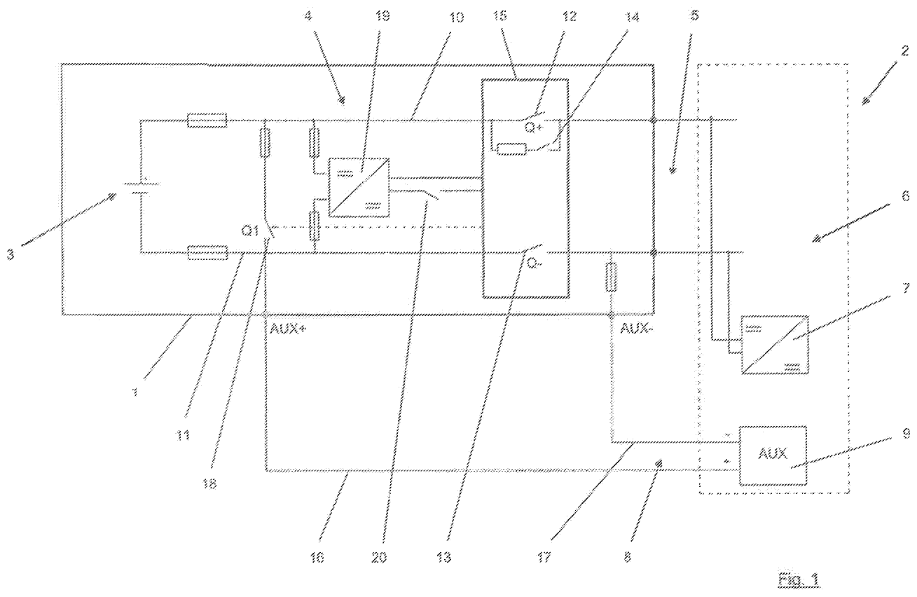

Further features and advantages of the invention will become apparent from the following description with reference to the single FIG. 1, which shows the design according to the invention in a schematic diagram.

### DETAILED DESCRIPTION

As can be seen from FIG. 1, the battery module 1 according to the invention has a battery 3 and switching electronics 4. The battery 3 is preferably a lithium-ion battery which in the embodiment shown serves to supply an on-board network 6 of a train 2.

The switching electronics 4 has a high-power path 5 on the one hand and an auxiliary path 8 on the other. The high-power path 5 serves to supply the on-board network 6 on the basis of a first on-board voltage 7, whereas the auxiliary path 8 serves to supply the on-board network 6 on the basis of a second on-board voltage 9.

The high-power path 5 has a first phase 10 with a first switching element 12 and a second phase 11 with a second switching element 13. The first switching element 12 and the second switching element 13 are components of a phase module 15. This phase module 15 also has a pre-charge 14 which is connected in parallel with the first switching element 12.

The auxiliary path 8 has a first phase 16 with a third switching element 18 and a second phase 17, wherein the second phase 17 is designed without switching elements.

The second phase of the auxiliary path 8 is connected in series with the second switching element 13 of the second phase 11 of the high-power path 5, i.e., the second phase 17 of the auxiliary path 8 is connected downstream of the second switching element 13 to the second phase 11 of the high-power path 5.

The first phase 16 of the auxiliary path 8 is connected upstream of the first switching element 12 to the first phase 10 of the high-power path 5.

The switching electronics 4 also has a DC voltage converter 19, which interacts with a fourth switching element 20.

As can be seen from the schematic diagram in FIG. 1, only one battery 3 is provided which serves equally to supply the on-board network 6 of the train 2 selectively with a first on-board voltage 7 or a second on-board voltage 9.

The switching electronics 4 described above also enables the method to be carried out as follows.

It is possible to start up the train 2 without external power supply. For this purpose, the fourth switching element 20 must be actuated, which actuation requests a power supply for a train-side control system. The second switching element 13 of the phase module 15 closes if the battery 3 is fault-free. The third switching element 18, which is designed as a contactor, for example, is then closed so that a voltage supply is provided via the auxiliary path 8 on the basis of the second on-board voltage 9. The auxiliary path is therefore active, so that the train 2 can then be started.

To start the train 2, the first switching element 12 of the phase module 15 must then be closed. As a result, the high-power path 5 is active and the train 2 is ready to go, since the power required to drive the drive motors is enabled.

In the event of an emergency stop on the train, i.e., if an emergency stop signal is emitted by the train, the power request with reference to the high-power path 5 is switched off. For this purpose, the first switching element 12 of the phase module 15 is opened. The train 2 then has no power available for the drive motors. However, the two switching elements 13 and 18 remain closed, which means that the auxiliary path 8 remains active, enabling emergency operation.

An optional emergency stop or unregulated shutdown in an emergency, in particular by auxiliary staff, is enabled by switching the switching elements 13 and 18. In this case, train 2 is completely de-energized.

1. A battery module for supplying an on-board network of a train, with a battery, and switching electronics, wherein the switching electronics have a high-power path for supplying the on-board network on the basis of a first on-board voltage and an auxiliary path for supplying the on-board network on the basis of a second on-board voltage, wherein the high-power path has a first phase with a first switching element and a second phase with a second switching element, wherein the auxiliary path has a first phase with a third switching element and a second phase, wherein the first phase of the auxiliary path is connected upstream of the first switching element to the first phase of the high-power path and wherein the second phase of the auxiliary path is connected downstream of the second switching element to the second phase of the high-power path, wherein the switching electronics has a DC voltage converter and wherein the DC voltage converter is configured to start up the battery without external power supply.

2. (canceled)

3. The battery module according to claim 1, wherein the DC voltage converter provides a second on-board voltage of 24 V.

4. (canceled)

5. A method for operating a battery module according to claim 1,
wherein a voltage supply of a train-side on-board network is requested by actuating a fourth switching element cooperating with the DC voltage converter,
wherein, in the event of a fault-free battery, the second switching element of the second phase of the high-power path is closed, and
wherein for supply of the on-board network based on the second on-board voltage, the third switching element in the first phase of the auxiliary path is closed.

6. The method according to claim 5, wherein the first switching element of the first phase of the high-power path is closed for supply of the on-board network on the basis of the first on-board voltage.

7. The method according to claim 6, wherein, in the event of a train-side emergency stop signal, the first switching element of the first phase of the high-power path is opened.

8. The method according to claim 5, wherein the third switching element of the first phase of the auxiliary path and/or the second switching element of the second phase of the high-power path is/are opened in order to disconnect the train from the power supply.
